(19) United States
(12) Patent Application Publication
(10) Pub. No.: US 2024/0154694 A1
(43) Pub. Date: May 9, 2024

(54) STATE ESTIMATION SYSTEM, SECRET SIGNAL GENERATOR, STATE ESTIMATION METHOD, SECRET SIGNAL GENERATION PROGRAM

(71) Applicant: Nippon Telegraph and Telephone Corporation, Tokyo (JP)

(72) Inventors: Takayuki NAKACHI, Musashino-shi, Tokyo (JP); Yitu WANG, Musashino-shi, Tokyo (JP); Yasuhiro MOCHIDA, Musashino-shi, Tokyo (JP); Takahiro YAMAGUCHI, Musashino-shi, Tokyo (JP); Hideki NISHIZAWA, Musashino-shi, Tokyo (JP)

(21) Appl. No.: 18/279,524

(22) PCT Filed: Mar. 2, 2021
(86) PCT No.: PCT/JP2021/007876

§ 371 Date: Aug. 30, 2023

(51) Int. Cl. H04B 10/079

(52) U.S. Cl. CPC H04B 10/0795; H04B 10/0791

(57) ABSTRACT

Provided is a concealment signal generation unit that acquires learning constellation data and identification constellation data output from a signal processing circuit for optical communication, reduces and conceals the number of pieces of data from each of the pieces of constellation data through random projection, and generates a learning concealment signal and an identification concealment signal based on each piece of constellation data after the reduction and concealment of the number of pieces of data. Provided are a sparse dictionary learning unit that learns a concealment sparse dictionary using a sparse dictionary learning algorithm based on the learning concealment signal; and an identification unit that estimates a state of the optical communication using the concealment sparse dictionary based on the identification concealment signal.

### TECHNICAL FIELD

The present invention relates to a state estimation system, a concealment signal generation device, a state estimation method, and a concealment signal generation program.

### BACKGROUND ART

In digital coherent communication, communication quality is confirmed by generating constellation data in which transmission data is expressed by polar coordinate diagrams with an amplitude and a phase and analyzing a deviation of the constellation data from a theoretical value. By checking the communication quality, it is possible to quickly identify a cause of a deterioration in the communication quality and take measures for improving the communication quality.

For example, Non Patent Literature 1 discloses an optical communication state estimation method using sparse coding.

### CITATION LIST

### Non Patent Literature

Non Patent Literature 1: Takayuki Nakachi, Yitu Wang, Tetsuro Inui, Takafumi Tanaka, Takahiro Yamaguchi, and Katsuhiro Shimano, “Intelligent Monitoring of Optical Fiber Transmission Using Sparse Coding”, Technical report of the institute of Electronics, Information and Communication Engineers (IEICE) Optical Communication System Study Group, vol. 119, no. 229, OCS2019-42, pp. 77-82.

### SUMMARY OF INVENTION

### Technical Problem

However, analysis of constellation data strongly depends on the experience of experts. In order to estimate a cause of quality degradation of optical communication by a statistical approach or deep learning, it is necessary to acquire a large amount of constellation data, and there is a problem that a calculation amount becomes enormous. However, in the technology disclosed in Non Patent Literature 1 described above, a reduction in the amount of data is not described, and the problem that an amount of calculation is enormous has not been solved.

The present invention has been made in view of the foregoing circumstances, and an objective of the present invention is to provide a state estimation system, a concealment signal generation device, a state estimation method, and a concealment signal generation program capable of estimating a cause of a degradation in quality of optical communication without an increase in a calculation amount.

### Solution to Problem

According to an aspect of the present invention, a state estimation system includes: a concealment signal generation unit configured to acquire learning constellation data and identification constellation data output from a signal processing circuit for optical communication, reduce and conceal the number of pieces of data from each of the pieces of constellation data through random projection, and generate a learning concealment signal and an identification concealment signal based on each piece of constellation data after the reduction and concealment of the number of pieces of data: a sparse dictionary learning unit configured to learn a concealment sparse dictionary using a sparse dictionary learning algorithm based on the learning concealment signal; and an identification unit configured to estimate a state of the optical communication using the concealment sparse dictionary based on the identification concealment signal.

According to another aspect of the present invention, a concealment signal generation device includes: a data acquisition unit configured to acquire learning constellation data and identification constellation data output from a signal processing circuit for optical communication; and a concealment signal generation unit configured to reduce and conceal the number of pieces of data from each of piece of constellation data through random projection and generate a learning concealment signal and an identification concealment signal based on each of constellation data after the reduction and concealment of the number of pieces of data.

According to another aspect of the present invention, a state estimation method includes: a step of acquiring learning constellation data output from a signal processing circuit for optical communication, reducing and concealing the number of pieces of data from the learning constellation data through random projection, and generating a learning concealment signal based on the learning constellation data after the reduction and concealment of the number of pieces of data; a step of learning a concealment sparse dictionary using a sparse dictionary learning algorithm based on the learning concealment signal; a step of acquiring identification constellation data output from a signal processing circuit of the optical communication, reducing and concealing the number of pieces of data from the identification constellation data through the random projection, and generating an identification concealment signal based on the identification constellation data after the reduction and concealment of the number of pieces of data; and a step of estimating a state of the optical communication using the concealment sparse dictionary based on the identification concealment signal.

According to another aspect of the present invention, a concealment signal generation program causes a computer to fun or as the concealment signal generation device.

### ADVANTAGEOUS EFFECTS OF INVENTION

According to the present invention, it is possible to estimate a cause of a degradation in quality of optical communication without an increase in the amount of computation.

### BRIEF DESCRIPTION OF DRAWINGS

FIG. 1 is a diagram illustrating 16-QAM constellation data.

FIG. 2A is a diagram illustrating constellation data when a modulator parent bias phase error occurs.

FIG. 2B is a diagram illustrating constellation data in an I/Q gain imbalance state.

FIG. 2C is a diagram illustrating constellation data in the I/Q skew imbalance state.

FIG. 3 is a block diagram illustrating a configuration of a state estimation system according to the present embodiment.

FIG. 4 is a block diagram illustrating a detailed configuration of a concealment signal generation unit.

FIG. 5 is a diagram illustrating a flow in which a concealment signal is generated through random projection from the number of pieces of constellation data or a histogram I(s, t).

FIG. 6 is a diagram illustrating a sparse model when the constellation data is not concealed.

FIG. 7 is a diagram illustrating a sparse model when dimensions are reduced and concealed through random projection.

FIG. 8 is a block diagram illustrating a hardware configuration.

### DESCRIPTION OF EMBODIMENTS

Hereinafter, a state estimation system according to the present embodiment will be described. In the present embodiment, a data amount of constellation data is reduced and concealed through random projection, and a state of optical communication is estimated using the constellation data after the data amount is reduced and concealed. Hereinafter, a “state estimation method using constellation data” and a “state estimation method based on concealment calculation in which random projection is used” will be described.

### State Estimation Method Using Constellation Data

As the constellation data, data transmitted in digital coherent communication can be expressed on a complex number plane. Phase and amplitude information of a coherent communication signal can be visually expressed by expressing the phase and amplitude information on the complex plane.

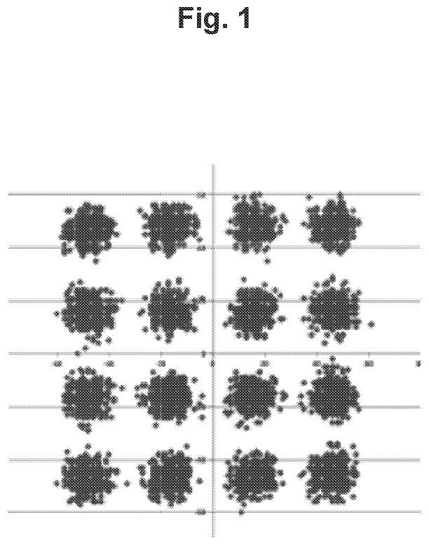

FIG. 1 is a diagram illustrating 16-QAM (quadrature amplitude modulation) constellation data. In positions of 16 points illustrated in FIG. 1, a rotation direction with respect to an axis indicates phase information, and a distance from the origin indicates amplitude information.

For example, in the case of a 16-QAM signal, 16 points (=4 bits) of information can be transmitted with one symbol. The constellation data represents an integrated state for a certain time, and a signal state indicates any one among 16 points at a certain time.

When the constellation data indicates a phase state and an amplitude state of a signal, it is possible to estimate a state of a transmission path and an optical transmitter according to the shape. Here, regarding state estimation of the optical transmitter, a specific example of the state estimation for three errors of a “modulator parent bias phase error”, an “I/Q gain imbalance state”, and an. “I/Q skew imbalance state” will be described. Each of the foregoing errors occurs mainly due to insufficient adjustment of an optical IQ modulation module of an optical communication device. Hereinafter, specific factors of the assumed error occurrence will be described the following (a) to (c).

### (a) Modulator Parent Bias Phase Error

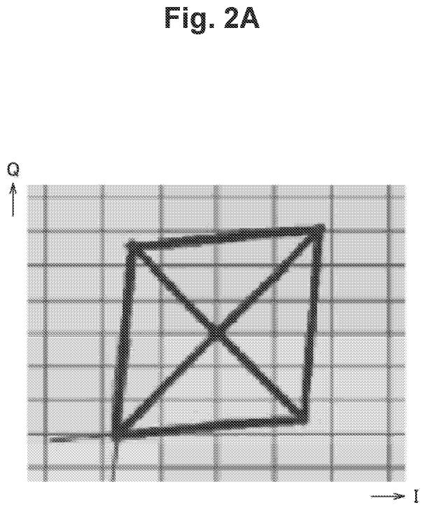

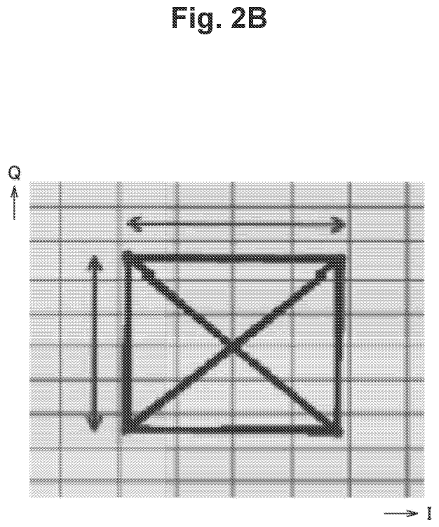

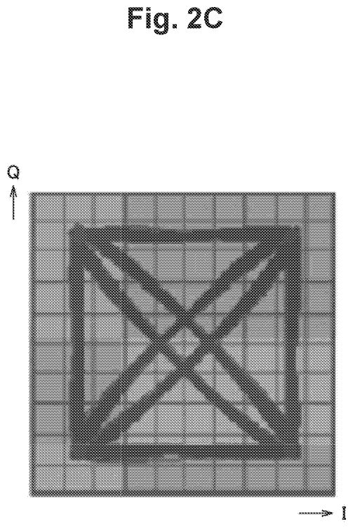

FIG. 2A is a diagram illustrating constellation data when a modulator parent bias phase error occurs. As illustrated in FIG. 2A, a phase shift causes the constellation data to be distorted in a rhombic shape. As a result, it can be determined that a deviation is likely to occur in a bias of the phase modulator.

### (b) I/Q Gain Imbalance State

FIG. 2B is a diagram illustrating the constellation data in the I/Q gain imbalance state. In this case, the I axis is longer than assumed or the Q axis is shorter than assumed. As a result, it can be determined that a deviation is likely to occur in a drive amplitude of “I” or “Q” of the optical I/Q modulator.

### (c) I/Q Skew Imbalance State

FIG. 25 is a diagram illustrating constellation data in an I/Q skew imbalance state. There are four corner points of a constellation map at the expected positions. However, a trajectory of transition from one point to another point is different from the assumed trajectory. As a result, it can be determined that a deviation is likely to occur in a correction value of a signal delay.

As described above, the communication quality of the digital coherent communication can be estimated by using the constellation data. In the present embodiment, when random projection is adopted, the constellation data is concealed and a data amount and a calculation load are reduced to estimate a state of optical communication.

### State Estimation Method Based on Concealment Calculation Using Random Projection

Hereinafter, a specific example of a state estimation method based on concealment calculation using random projection will be described. Hereinafter, [1. Overview of State Estimation System], [2. Generation of Concealment Signal Using Random Projection], [3. General Sparse Dictionary Learning and identification], and [4. Concealment Sparse Dictionary Learning and Concealment Identification] will be described.

### 1. Overview of State Estimation System

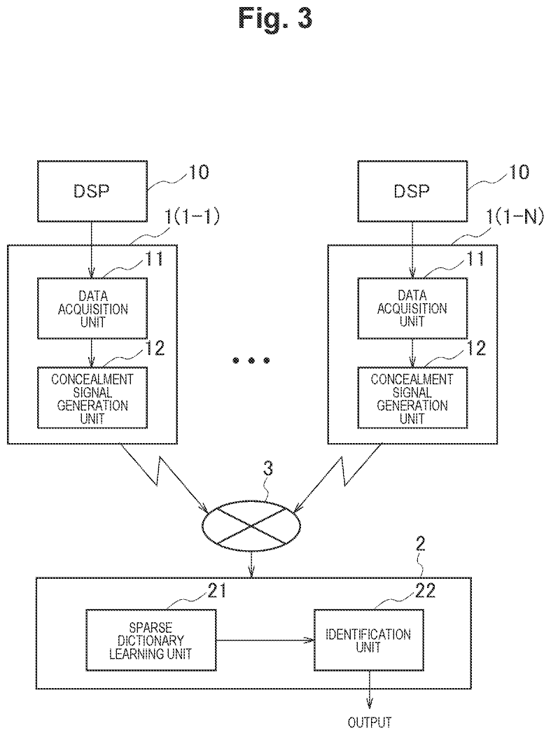

An overview of a state estimation system that executes state estimation of optical communication using concealment sparse coding will be described. FIG. 3 is a block diagram illustrating a configuration of a state estimation system 100 according to the present embodiment.

As illustrated in FIG. 3, the state estimation system 100 according to the present embodiment includes a plurality of concealment signal generation devices 1 (1-1 to 1-N) and a calculation device z. Each concealment signal generation device 1 and the calculation device 2 are connected via a network 3.

Each of the concealment signal generation devices 1 (1-1 to 1-N) includes a data acquisition unit 11 and a concealment signal generation unit 12. The calculation device 2 includes a sparse dictionary learning unit 21 and an identification unit 22.

The data acquisition unit 11 is connected to a digital coherent signal processing circuit 10 (hereinafter referred to as a “DSP 10”).

The DSP 10 processes signals transmitted and received in digital coherent communication. The data acquisition unit 11 acquires constellation data from the DSP 10.

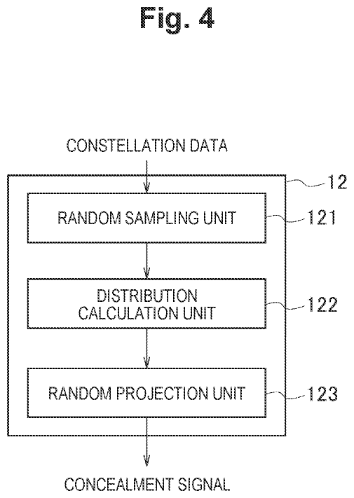

The concealment signal generation unit 12 generates a concealment signal (a learning concealment signal) based on the learning constellation data acquired by the data acquisition unit 11. The concealment signal generation unit 12 also generates a concealment signal (an identification concealment signal) based on the identification constellation data acquired by the data acquisition unit 11. The details of the concealment signal generation unit 12 will be described below with reference to FIG. 4.

The sparse dictionary learning unit 21 learns a concealment sparse dictionary using the “label consistent K-SVD algorithm” (hereinafter referred to as an “LC K-SVD algorithm”) of a sparse dictionary learning method.

The identification unit 22 calculates a sparse coefficient (of which the details will be described below) by using the concealment sparse dictionary learned by the sparse dictionary learning unit 21 and an orthogonal matching pursuit (OMP) which is an example of a greedy algorithm.

In the state estimation system 100 according to the present embodiment, the concealment signal generation device 1 and the calculation device 2 execute a step of the concealment sparse dictionary learning and a step of the concealment identification to be described below, calculate the sparse coefficient, and estimate the concealment state of optical communication.

In the step of the concealment sparse dictionary learning, learning is executed based on information regarding whether the learning constellation data is normal or an error, and what the error state is when the learning constellation data is the error, and a parameter such as a sparse dictionary is determined.

In the step of the concealment sparse dictionary learning, the concealment signal generation device 1 acquires the constellation data from the DSP 10 and generates the concealment signal. Thereafter, the generated concealment signal is transmitted to the calculation device 2 via the network 3.

The sparse dictionary learning unit 21 of the calculation device 2 learns the concealment sparse dictionary using the “LC K-SVD” algorithm of the sparse dictionary learning method.

In the step of the concealment identification, the concealment signal generation device 1 (1-1 to 1-N) installed in each base acquires the identification constellation data from the DSP 10 and generates a concealment signal. Subsequently, a process of identifying whether the identification constellation data is normal or in an error state is executed using the concealment sparse dictionary estimated in the step of the above-described concealment sparse dictionary learning.

### 2. Generation of Concealment Signal Using Random Projection

Next, generation of the concealment signal using the random projection will be described in detail. The generation of the concealment signal is common to the step of the concealment sparse dictionary learning and the step of the concealment identification described above. FIG. 4 is a block diagram illustrating a detailed configuration of the concealment signal generation unit 12. As illustrated in FIG. 4, the concealment signal generation unit 12 includes a random sampling unit 121, a distribution calculation unit and a random projection unit 123. Detailed description will be made below.

### 2-1. Random Sampling Unit 121

The random sampling unit 121 executes a process of reducing the number of pieces of sample data through the random projection. In the random projection, original d-dimensional data “X_{d×N}” is projected to a k-dimensional (where k<<d) subspace using a random matrix “R_{k×d}” of “k×d” in which a unit length of a column is random. That is, the data “X^{RP}_{k×N}” after the random projection is calculated with the following Expression (1).

[Math. 1]

X_{k×N}^{RP}=R_{k×d}X_{d×N} (1)

When each element of the randomization matrix “R” is “rij”, each constituent “rij” is set as in the following Expression (2). Accordingly, the number of pieces of data can be reduced by executing random projection. Expression (2) is an example of the randomization matrix “R”. A randomization matrix “R” for general random projection can be used.

$$\begin{matrix}[ Math . 2 ] & \\ {r}_{ij} = \sqrt{3} \cdot \{ \begin{matrix}+ 1 & with probability \frac{1}{6} \\ 0 & with probability \frac{2}{3} \\ - 1 & with probability \frac{1}{6}\end{matrix} & ( 2 )\end{matrix}$$

### 2-2. Distribution Calculation Unit 122

The distribution calculation unit 122 calculates the number of pieces of constellation data or a histogram “I (s, t)” belonging to coordinates s, t (s=1, . . . , S, and t=1, . . . , T) in the constellation data acquired from the DSP 10.

### 2-2. Random Projection Unit 123

The random projection unit 123 reduces the number of pieces of data using random projection in which both dimension reduction and a concealment process can simultaneously be implemented based on the number of pieces of constellation data calculated by the distribution calculation unit 122 or the histogram. “I(s, t)”.

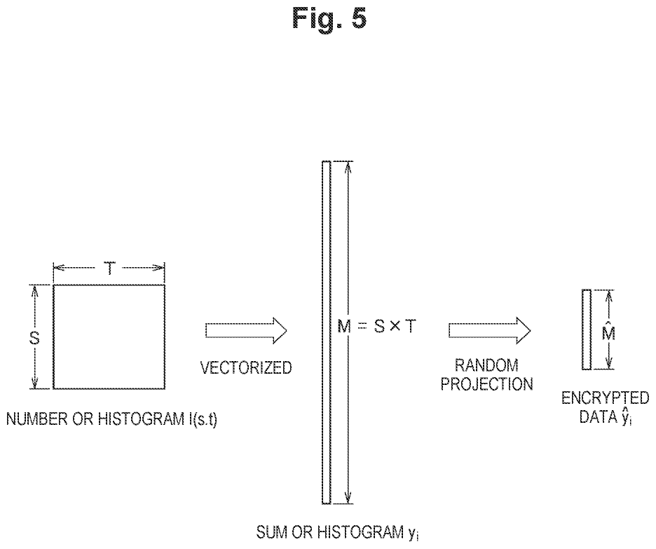

FIG. 5 is a diagram illustrating a flow in which a concealment signal is generated through the random projection from the number of pieces of constellation data or the histogram “I(s, t)”. As illustrated in FIG. 5, first, the histogram. “I(s, t)” is rearranged in a lexicographic order as in the following Expression (4) by a column vector “yi” expressed by the following Expression (3).

[Math. 3]

yᵢ∈ [symbol] ^{M} (3)

[Math. 4]

yᵢ=[I(1,1), . . . , I(S,1), I(1,2), . . . , I(S,2), . . . , I(1,T), . . . , I(S,T)]^{T} (4)

In Expression (3), “M” is a non-negative integer defined by “S×T”, and “i” indicates a sample index of learning data or identification data and is “i=1, . . . , N”. “N” indicates the number of pieces of data.

The random projection is linear transformation by a random matrix and can be used to reduce dimensionality of high-dimensional data. In the random projection, a matrix R expressed in the following Expression (5) using a random number as an element is multiplied by an M-dimensional vector “yi” to be converted into a low-dimensional vector “yi(\hat{ })” that has an “M(\hat{ })” dimension (where M(\hat{ })<M). The vector “yi(\hat{ })” can be expressed by the following Expression (6).

[Math. 5]

R∈ [symbol] \hat{M}×M (5)

[Math. 6]

ŷᵢ=Ryᵢ (6)

If elements of the random matrix R are random numbers of which an average is “0” and a variance “1/M(\hat{ })”, the data is approximately stored with a high probability of a distance between the data before and after the random projection, as expressed in the following Expression (8) at the time of execution of random projection of any N pieces of learning data or identification data “yi (where i=1, . . . , N)” to the dimension of the following Expression (7).

[Math. 7]

\hat{M}=O(∈⁻²logM (7)

[Math. 8]

(1−∈)∥yᵢ−yⱼ∥₂≤∥ŷᵢ−ŷⱼ∥₂≤(1−∈)∥yᵢ−yⱼ∥₂ (8)

In Expression (8), “ϵ” (where 0<ϵ<1) is a coefficient. This theorem indicates that at the time of mapping from an “M”-dimensional space to a space of a lower dimension “M(\hat{ })”, a Euclidean distance be two certain points is stored with a considerably high probability. Further, it is known that this random projection is obtained by any random value. Through the above-described process, a concealment signal through the random projection is generated.

### 3. General Sparse Dictionary Learning and Identification

Next, sparse dictionary learning and identification when the vector “yi” is not concealed will be described. The sparse dictionary learning is executed by supervised sparse dictionary learning “LC K-SVD”. The unsupervised sparse dictionary learning “K-SVD” is required for a process of “LC K-SVD”. Therefore, “K-SVD” will be described first.

### 3-1. Unsupervised Sparse Dictionary Learning: K-SVD

A set “Y” of vectors “yi” is expressed by the following Expression (9).

[Math. 9]

Y={yᵢ}ᵢ₌₁^{N} (9)

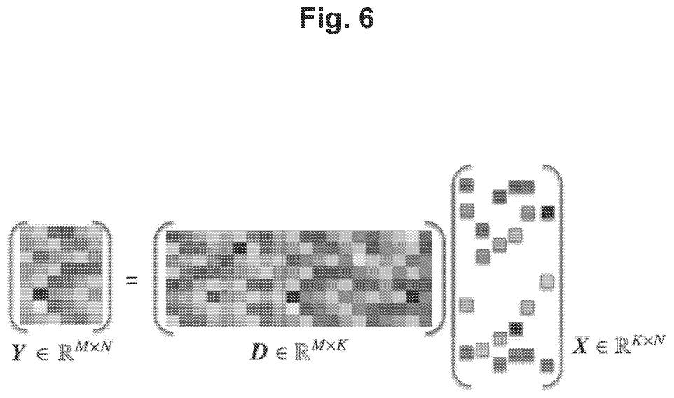

FIG. 6 is a diagram illustrating a sparse model when constellation data is not concealed. A blank portion illustrated in FIG. 6 indicates that data is “0”. Here, as illustrated in FIG. 6, it is assumed that the set “Y” can be expressed by a linear combination of K bases. That is, the following Expression (10) is assumed.

[Math. 10]

Y=DX (10)

Here, “D” expressed in Expression (10) can be expressed as the following Expression (11). “X” expressed in Expression (10) can be expressed as the following Expression (12).

[Math. 11]

D={d₁, . . . , d_{K}}∈ [symbol] ^{M×K} (11)

[Math. 12]

X={xᵢ}ᵢ₌₁^{N} (12)

In Expressions (11) and (12), “D” is a dictionary matrix that has a base “dk” (M-dimensional column vector) as an element, and “X” is a matrix that has a sparse coefficient “xi” (K-dimensional column vector) as an element.

In general, as the dictionary matrix, an over complete dictionary matrix in which the number of bases is larger than the dimensions of an observation signal (that is, “K>M”) is used. In an expression “Y=DX” (the above-described Expression (10)) by bases greater than the dimensions of the observation signal, uniqueness of “X” cannot be guaranteed.

Therefore, the base usually used to express the observation signal “Y” is limited to some of “D”. That is, a constraint which only a small number “T0” of coefficients take non-zero values, and most of the remaining coefficients take zero values is provided. In this way, a state in which the number of non-zero elements is small with respect to all the elements is called sparse. An optimization problem that has the sparse constraint is formulated as the following Expression (13) that minimizes the reconfiguration error.

$$\begin{matrix}[ Math . 13 ] & \\ 〈 D , X 〉 = {min}_{DX} {‖ Y - DX ‖}_{F}^{2} subject to ∀ i , {‖ {x}_{i} ‖}_{0} < {T}_{0} & ( 13 )\end{matrix}$$

However, the following Expression (14) indicated by Expression (13) represents the L0 norm (the number of non-zero elements in the vectors).

[Math. 14]

∥·∥₀ (14)

The following Expression (15) indicates the norm of Frobenius and is defined as in the following Expression (16).

[Math. 15]

∥·∥_{F} (15)

[Math. 16]

∥A∥_{F}=\sqrt{ΣᵢⱼAᵢⱼ²} (16)

In general, dictionary learning solves the optimization problem of the above-described Expression (13) by alternately repeating the following two steps S1 and S2. The sparse coefficient is calculated in step S1 to be described below, and the dictionary is updated in step S2.

### Step S1; Calculation of Sparse Coefficient

In step S1, there is a problem of fixing the dictionary D and obtaining the sparse coefficient xi, which can be rewritten as the following Expression (17).

$$\begin{matrix}[ Math . 17 ] & \\ {x}_{i} = {arg min}_{{x}_{i}} {‖ {y}_{i} - {Dx}_{i} ‖}_{2}^{2} subject to {‖ {x}_{i} ‖}_{0} < {T}_{0} & ( 17 )\end{matrix}$$

$$i = 1 , 2 , … , N$$

However, this problem is a combination optimization problem in which an optimum solution cannot be obtained unless all combinations of the bases are tested, and it is known that this problem is computationally difficult. (NP-hard). As a solution to this problem, many algorithms, such as a method based on a greedy method and a method of solving the problem after relaxing 10 constraints with 11 constraints, have been proposed. As an example, in the present invention, orthogonal matching pursuit (OMP) which is an approximation solution based on 10 constraints is used.

### Step S2; Updating Dictionary

In step S2, the dictionary “D” is update by fixing “X (a matrix that has the sparse coefficient xi as an element)” obtained in step S1. “K-SVD” is placed by generalizing a “k-means” method. While clusters and samples have a one-to-one correspondence in the “k-means” method, samples are represented as a primary combination of cluster centroids (the bases in the K-SVD) in the “K-SVD” method. In “K-SVD”, a residual “Ek” with a linear prediction value obtained by removing a base “dk” from a set “Y” of observation signals is subjected to singular value decomposition (SVD) to obtain “dk” and “x^{k}_{T}”. The residual “Ek” is expressed in the following Expression (18).

$$\begin{matrix}[ Math . 18 ] & \\ {E}_{k} = Y - {\sum }_{j \neq k}^{K} {d}_{j} {x}_{T}^{j} & ( 18 )\end{matrix}$$

However, since the obtained solution does not always satisfy the sparse constraint, only the non-zero element in “x^{k}_{T}” obtained in step S1 is updated in “K-SVD”. By applying “SVD” to an error “E^{R}ₖ” at that time and decomposing the error into orthogonal matrices “U” and “V” and a diagonal matrix “Σ”, the following Expression (19) is obtained.

$$\begin{matrix}[ Math . 19 ] & \\ \begin{matrix}{E}_{k}^{R} = U Δ {V}^{T} \\ = {u}_{1} \cdot {σ}_{1} {v}_{i}^{T} + {u}_{2} \cdot {σ}_{2} {v}_{2}^{T} + … + {u}_{n} \cdot {σ}_{n} {v}_{n}^{T}\end{matrix} & ( 19 )\end{matrix}$$

In Expression (19), “ui” and “vj” are i-th column vectors of “U” and “V”, respectively, and “σi” is an i-th diagonal component of “Δ”. In “K-SVD”, an approximate solution of a row vector of the base and the sparse coefficient is obtained as in the following Expression (20) using a component “u1” related to the first singular value and “σ1v^{T}₁”.

$$\begin{matrix}[ Math . 20 ] & \\ \begin{matrix}\cdot Base : {d}_{k} = {u}_{1} \\ \cdot Sparse coefficient : {x}_{R}^{k} = {σ}_{1} {v}_{1}^{T}\end{matrix} \} & ( 20 )\end{matrix}$$

### 3-2. Supervised Sparse Dictionary Learning: LC K-SVD

The supervised sparse dictionary learning is executed by the sparse dictionary learning unit 21 illustrated in FIG. 3. While “K-SVD” obtains a sparse representation so that a reconfiguration error is minimized, a cost function is set as a weighted sum of (a) a reconfiguration error, (b) an identification sparse code error, and (c) an identification error for classification, and the sparse representation is learned with the following Expression (21) in “LC K-SVD”.

$$\begin{matrix}[ Math . 21 ] & \\ 〈 D , W , A , X 〉 = {min}_{D , W , A , X} {‖ Y - DX ‖}_{F}^{2} + α {‖ Q - AX ‖}_{F}^{2} + β {‖ H - WX ‖}_{F}^{2} & ( 21 )\end{matrix}$$

$$subject to {‖ {x}_{i} ‖}_{0} < {T}_{0}$$

The first term on the right side of Expression (21) is the same reconfiguration error as “K-SVD”. “Q” expressed in the following Expression (22) of the second term on the right side of the Expression (21) is an identification sparse code for classification of the vector “yi” of the observation signal, and the vector “yi” of the observation signal classified into the same class imposes a constraint that the same base “dk” is shared.

[Math. 22]

Q=[q₁, . . . , qₙ]∈ [symbol] ^{L×N} (22)

The third term on the right side of the Expression (21) is an identification error or classification. “W” is a projection matrix for classification, and “H” expressed in the following expression (23) is a class label of an input “Y”.

[Math. 23]

H=[h₁, . . . , h_{N}]∈ [symbol] ^{m×N} (23)

“hi” expressed in Expression (23) can be expressed as the following Expression (24). “hi” is a label vector of a class corresponding to the vector “yi” of the observation signal, “l” indicates a corresponding class, and “m” indicates the number of classes.

[Math. 24]

hᵢ=[0, 0 . . . 1 . . . 0, 0]^{T}∈ [symbol] ^{m} (24)

“α” and “β” expressed in the above-described Expression (21) are parameters for adjusting a contribution rate. The Expression (21) can be rewritten to the following Expression (25). This has the same form as the above-described Expression (13), and the dictionary can be learned by an algorithm similar to “K-SVD”.

$$\begin{matrix}[ Math . 25 ] & \\ 〈 T , X 〉 = {min}_{D , W , A} {‖ Z - TX ‖}_{F}^{2} subject to {‖ {x}_{i} ‖}_{0} < {T}_{0} where & ( 25 )\end{matrix}$$

$$Z = [ \begin{matrix}Y \\ \sqrt{α} Q \\ \sqrt{β} H\end{matrix} ] T = [ \begin{matrix}D \\ \sqrt{α} A \\ \sqrt{β} W\end{matrix} ]$$

### 3-3. Identification

The identification process is executed by the identification unit 22 illustrated in FIG. 3. In the identification step, a sparse coefficient “xi” is calculated by solving the following Expression (26) for the vector “yi” of an observation signal shaped from the identification constellation data using the dictionary “D” estimated by “LC K-SVD” using “OMP” or the like.

$$\begin{matrix}[ Math . 26 ] & \\ {x}_{i} = {arg min}_{{x}_{i}} {‖ {y}_{i} - {Dx}_{i} ‖}_{2}^{2} subject to {‖ {x}_{i} ‖}_{0} < {T}_{0} & ( 26 )\end{matrix}$$

Subsequently, the calculated sparse coefficient “xi” is projected using a matrix “W” with the following Expression (27).

[Math. 27]

ĥᵢ=Wxᵢ (27)

It is identified whether the vector “yi(\hat{ })” of the concealment signal belongs to any one of the “m” classes based on the estimated value “hi (\hat{ })” after the projection. The vector “yi(\hat{ })” is identified in a class corresponding to an element closest to “l” in “hi(\hat{ })”.

### 4. Concealment Sparse Dictionary Learning and Concealment Identification

Processes for the concealment sparse dictionary learning and the concealment identification are executed by the sparse dictionary learning unit 21 and the identification unit 22 illustrated in FIG. 3. In the processes, the concealment sparse learning and the identification are executed using the vector “yi(\hat{ })” of the concealment signal generated through the random projection based on the constellation data.

### 4-1. Supervised Concealment Sparse Dictionary Learning: LC K-SVD

Hereinafter, supervised concealment sparse dictionary learning be described. A set of vectors “yi(\hat{ })” of the concealment signal is expressed as in the following Expression (28).

[Math. 28]

Ŷ={ŷᵢ}ᵢ₌₁^{N} (28)

At this time, the concealment dictionary “D(\hat{ })” and the projection matrix “W” expressed by the following Expression (29) are obtained using “LC K-SVD”.

[Math. 29]

\hat{D}∈ [symbol] ^{\hat{M}×K} (29)

A cost function of the concealment sparse dictionary learning in which “LC K-SVD” is used can be expressed with the following Expression (30) and can be solved by an algorithm similar to “K-SVD”.

$$\begin{matrix}[ Math . 30 ] & \\ 〈 \hat{T} , X 〉 = {min}_{\hat{D} , W , A} {‖ \hat{Z} - \hat{T} X ‖}_{F}^{2} subject to {‖ {x}_{i} ‖}_{0} < {T}_{0} where & ( 30 )\end{matrix}$$

$$\hat{Z} = [ \begin{matrix}\hat{Y} \\ \sqrt{α} Q \\ \sqrt{β} H\end{matrix} ] \hat{T} = [ \begin{matrix}\hat{D} \\ \sqrt{α} A \\ \sqrt{β} W\end{matrix} ]$$

Here, “Q” expressed in the following Expression (31) is an identification sparse code for classification of the vectors “yi” of the observation signal, and “W” expressed in Expression (30) is a projection matrix for classification. “H” expressed in the following Expression (32) is a class label of the input “Y”.

[Math. 31]

Q=[q₁, . . . ,qₙ]∈ [symbol] ^{K×N} (31)

[Math. 32]

H=[h₁, . . . , h_{N}]∈ [symbol] ^{m×N} (32)

“hi” expressed in the following Expression (33) is a label vector of a class corresponding to the vector “yi” of the observation signal, “l” indicates a corresponding class, and “m” indicates the number of classes.

[Math. 33]

hᵢ=[0, 0 . . . 1 . . . 0, 0]^{T}∈ [symbol] ^{m} (33)

“α” and “β” expressed in the Expression (30) are parameters for adjusting a contribution rate. It is assumed that the dictionary “D” is concealed through the random projection according to the relationship of “D(\hat{ })=RD(\hat{ })”.

Here, as expressed in the above-described Expression (8), a distance between the data is approximately stored at a high probability before and after the random projection. Therefore, an optimum solution of the concealment sparse dictionary learning of the above-described Expression (30) is calculated as a value close to the optimum solution of Expression (25) when the dictionary is not concealed.

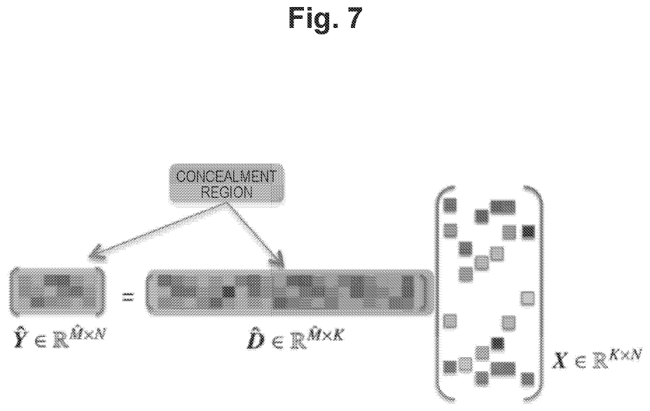

At this time, the concealment dictionary “D(\hat{ })” can be updated and obtained in a region of the concealment signal by the “LC K-SVD” algorithm. As described above, FIG. 6 is a diagram illustrating a sparse model when constellation data is not concealed. FIG. 7 is a diagram illustrating a sparse model when dimensions are reduced and concealed through the random projection. As can be understood by comparing FIGS. 6 and 7, by reducing the dimensions “Y” and “D” through the random projection, it can be understood that the dimensions of the learning or identification data and the dictionary are small and concealed.

### 4-2. Concealment Identification

The concealment identification process is executed by the identification unit 22 illustrated in FIG. 3. In the step of the concealment identification, the concealment dictionary “D(\hat{ })” estimated in the concealment sparse dictionary learning is used for the concealment signal “y(\hat{ })I” generated through the random projection from the identification constellation data, and the following Expression (34) is solved by “OMP” or the like to calculate the sparse coefficient “xi”.

$$\begin{matrix}[ Math . 34 ] & \\ {x}_{i} = {arg min}_{{x}_{i}} {‖ {\hat{y}}_{i} - \hat{D} {x}_{i} ‖}_{2}^{2} subject to {‖ {x}_{i} ‖}_{0} < {T}_{0} & ( 34 )\end{matrix}$$

Next, the calculated sparse coefficient “xi” is projected with the following Expression (35) using the projection matrix “W” estimated in the concealment sparse dictionary learning.

[Math. 35]

ĥᵢ=Wxᵢ (35)

It is identified to which class the vector “yi(\hat{ })” of the concealment signal belongs among the “m” classes based on the estimated value “h(?)i” after the projection. Then, the vector “yi(\hat{ })” of the concealment signal can be identified as the class corresponding to the element closest to “l” of “h(\hat{ })i”.

### Effects of Present Embodiment

As described above, the state estimation system 100 according to the present embodiment includes: the concealment signal generation unit 12 configured to acquire learning constellation data and identification constellation data output from a signal processing circuit for optical communication, reduce and conceal the number of pieces of data from each of the pieces of constellation data through random projection, and generate a learning concealment signal and an identification concealment signal based on each piece of constellation data after the reduction and concealment of the number of pieces of data: the sparse dictionary learning unit 21 configured to learn a concealment sparse dictionary using a sparse dictionary learning algorithm based on the learning concealment signal; and the identification unit 22 configured to estimate a state of the optical communication using the concealment sparse dictionary based on the identification concealment signal.

In the present embodiment, it is possible to reduce the constellation data when the constellation data is concealed. Therefore, it is possible to estimate a state of the transmission path or the optical transmitter in optical communication with a small calculation amount while keeping high concealment. As a result, it is possible to estimate a cause of a degradation in quality of optical communication without an increase in the amount of computation.

Even when data is leaked due to an artificial mistake, it is possible to prevent data leakage.

The concealment signal generation unit 12 reduces the number of pieces of constellation data in the random sampling unit. Further, the distribution calculation is executed on the constellation data after the reduction in the number of pieces of data, and the random projection in which the dimension reduction and the concealment process are simultaneously implemented is executed to generate the learning concealment signal and the identification concealment signal. Therefore, the learning concealment signal and the identification concealment signal can be generated with high accuracy.

Further, the sparse dictionary learning unit 21 updates the sparse coefficient “xi”, the concealment dictionary “D(\hat{ })”, and the projection matrix “W” by learning the concealment sparse dictionary. Therefore, the sparse dictionary learning can be always executed by adopting new data.

Since the identification unit 22 updates the sparse coefficient “xi”, the concealment dictionary “D(\hat{ })”, and the projection matrix “W” estimated by the sparse dictionary learning unit 21, it is possible to execute state estimation of optical communication with high accuracy.

Further, as illustrated in FIG. 3, by providing a plurality of (N in the figure) concealment signal generation devices 1, a plurality of concealment signal generation units 12 is provided. Therefore, it is possible to execute the state estimation on the constellation data obtained from the DSP 11 provided in each base.

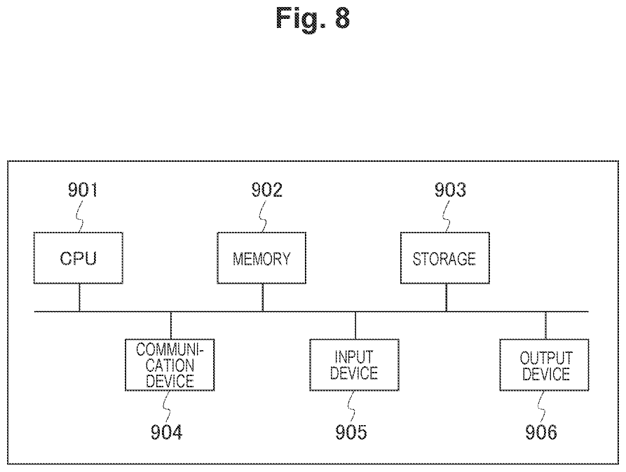

As illustrated in FIG. 8, as the concealment signal generation device 1 according to the above-described present embodiment, for example, a general-purpose computer system including a central processing unit (CPU or a processor) 901, a memory 902, a storage 903 (a hard disk drive (HDD) or a solid state drive (SSD)), a communication device 904, an input device 905, and an output device 906 can be used. The memory 902 and the storage 903 are storage devices. In the computer system, each function of the concealment signal generation device 1 is implemented by the CPU 901 executing a predetermined program loaded on the memory 902.

The concealment signal generation device 1 may be implemented by one computer or may be implemented by a plurality of computers. Alternatively, the concealment signal generation device 1 may be a virtual machine mounted on a computer.

A program for the concealment signal generation device 1 can be stored in a computer-readable recording medium such as an HDD, an SSD, a universal serial bus (USB) memory, a compact disc (CD), or a digital versatile disc (DVD) or can be distributed via a network.

The present invention is not limited to the foregoing embodiment, and various modifications can be made within the scope of the gist of the present, invention.

### REFERENCE SIGNS LIST

1(1-1 to 1-N) Concealment signal generation device
2 Calculation device
3 Network
10 Digital coherent signal processing circuit (DSP)
11 Data acquisition unit
12 Concealment signal generation unit
21 Sparse dictionary learning unit
22 Identification unit
100 State estimation system
121 random sampling unit
122 Distribution calculation unit
123 Random projection unit

1. A state estimation system comprising:
a concealment signal generation unit, implemented using one or more computing devices, configured to:
acquire learning constellation data and identification constellation data output from a signal processing circuit for optical communication,
reduce and conceal a number of pieces of data from each of pieces of constellation data through random projection, and
generate a learning concealment signal and an identification concealment signal based on each piece of constellation data after the reduction and concealment of the number of pieces of data;
a sparse dictionary learning unit, implemented using one or more computing devices, configured to learn a concealment sparse dictionary using a sparse dictionary learning algorithm based on the learning concealment signal; and
an identification unit, implemented using one or more computing devices, configured to estimate a state of the optical communication using the concealment sparse dictionary based on the identification concealment signal.

2. The state estimation system according to claim 1, wherein the concealment signal generation unit is configured to generate the learning concealment signal and the identification concealment signal by executing random projection in which distribution calculation, dimension reduction, and a concealment process are simultaneously implemented based on each piece of constellation data after the reduction and concealment of the number of pieces of data.

3. The state estimation system according to claim 1, wherein the sparse dictionary learning unit is configured to update a sparse coefficient, a concealment dictionary, and a projection matrix by learning the concealment sparse dictionary.

4. The state estimation system according to claim 3, wherein the identification unit is configured to estimate the state of the optical communication based on the sparse coefficient estimated by the sparse dictionary learning unit and the concealment dictionary.

5. The state estimation system according to claim 1, wherein the concealment signal generation unit is provided in plurality.

6. A concealment signal generation device comprising:
a data acquisition unit, implemented using one or more computing devices, configured to acquire learning constellation data and identification constellation data output from a signal processing circuit for optical communication; and
a concealment signal generation unit, implemented using one or more computing devices, configured to:
reduce and conceal a number of pieces of data from each of pieces of constellation data through random projection, and
generate a learning concealment signal and an identification concealment signal based on each of constellation data after the reduction and concealment of the number of pieces of data.

7. A state estimation method comprising:
acquiring learning constellation data output from a signal processing circuit for optical communication;
reducing and concealing a number of pieces of data from the learning constellation data through random projection;
generating a learning concealment signal based on the learning constellation data after the reduction and concealment of the number of pieces of data from the learning constellation data;
learning a concealment sparse dictionary using a sparse dictionary learning algorithm based on the learning concealment signal;
acquiring identification constellation data output from the signal processing circuit for optical communication;
reducing and concealing a number of pieces of data from the identification constellation data through the random projection;
generating an identification concealment signal based on the identification constellation data after the reduction and concealment of the number of pieces of data from the identification constellation data; and
estimating a state of the optical communication using the concealment sparse dictionary based on the identification concealment signal.

8. (canceled)
